(19) United States
(12) Patent Application Publication
(10) Pub. No.: US 2016/0279020 A1
(43) Pub. Date: Sep. 29, 2016

(54) Device and Method for Sexual Stimulation of a Penis

(71) Applicant: KIIROO B.V., GA Amsterdam (NL)

(72) Inventor: Toon Timmermans, Amsterdam (NL)

(73) Assignee: KIIROO B.V., Amsterdam (NL)

(21) Appl. No.: 15/031,363

(22) PCT Filed: Oct. 20, 2014
(86) PCT No.: PCT/NL2014/050731

§ 371 Date: Apr. 22, 2016

(30) Foreign Application Priority Data
Oct. 22, 2013 (NL) 2011661

(51) Int. Cl. A61H 19/00

(52) U.S. Cl. CPC A61H 19/50; A61H 19/00; A61H 19/32; A61H 19/44; A61H 19/40; A61H 2201/0153; A61H 2201/1418; A61H 2201/149; A61H 2201/5002; A61H 2201/5005; A61H 2201/501; A61H 2201/5012; A61H 2201/5028; A61H 2201/5043; A61H 2201/5058; A61H 2201/5071; A61H 2201/5097

(57) ABSTRACT

The invention relates to a device for sexual stimulation of a penis, with a housing with a substantially cylindrical cavity, a number of constriction elements with an opening which are placed in the housing and arranged adjacently of each other in axial direction, wherein the cavity extends through each of the openings and the constriction elements are each configured, when activated, to constrict their opening, and a control element placed in the housing for controlling the controllable size of the opening of each of the constriction elements, wherein the control element is configured to generate at least one reciprocally moving constriction of the constriction elements displacing over the length of the cavity along the constriction elements, at a frequency of between 0.2 and 5 reciprocal movements per second. The invention also relates to an apparatus for use by a sexual partner of the user of the device, which is configured for placing in the vagina of the sexual partner and provided with a number of pressure sensors and elongate sensor configured to detect the extent to which the apparatus has been inserted into the vagina.

The invention relates to a device for sexual stimulation of a penis. The invention more particularly comprises such a device comprising a housing with a substantially cylindrical cavity which is open on at least one end and configured to receive a penis, a number of constriction elements with an opening which are placed in the housing and arranged adjacently of each other in axial direction, wherein the cavity extends through each of the openings and the constriction elements are each configured, when activated, to constrict their opening, and a control element placed in the housing for controlling the controllable size of the opening of each of the constriction elements.

Such a device is known from WO-A-03/017047. In this known device the constriction elements are controlled by an external source, such as an apparatus used by a sexual partner and provided with pressure sensors, for instance for transmitting the constriction and the force exerted by the wall of a vagina. This thus controlled prior art device hereby simulates a vagina, a mouth, a first or other body part used for sexual stimulation. It is possible to connect such a device via the internet to an apparatus provided with pressure sensors, so that virtual sexual contact is possible at great distances. Use is usually also made of a video and audio connection during such a session. This prior art device however only simulates the vagina or the other body part; the device has to be moved reciprocally in order to gratify the user.

The object of the invention is to provide such a device which can be placed around the penis and which further need not be moved for the purpose of achieving user gratification.

This object is achieved with a device of the above stated type, wherein the control element is configured to generate at least one temporary constriction of the constriction elements displacing over the length of the cavity along the constriction elements at a frequency of between 0.2 and 5 movements per second. The invention can also be applied at a frequency of between 0.1 and 10 movements per second, although it is recommended to make use of frequencies between 0.5 and 2 movements per second.

By bringing about successive contraction of the constriction elements a peristaltic movement is simulated in the manner of a propagating wave, and this results in sexual stimulation. This movement simulates the movement which takes place between penis and vagina or other body part during sexual stimulation, so that the device no longer need be moved to obtain sexual stimulation and gratification. These acts can be performed with an erect penis, although it is possible that a penis is inserted into the device in limp state and that through sexual stimulation the penis moves into the erect state.

It is noted that a similar device is known from WO-A-2010/042884 which is provided with two belts placed on either side of a cavity, each mounted around two shafts and each driven by one of the shafts. The belts are provided with ridges which through the movement of the belts generate a sensation which simulates the movement between the penis and the body part of the sexual partner. In contrast to the movement which is actually taking place, this movement is only propagated in a single direction. This is also the case in the present invention, although in the invention there is a single constriction which develops gradually, while in the prior art there is a propagating series of constrictions. The relative movement between the belts and the sheath of the cavity also results in heavy wear. No movement need thus take place here between the penis and the parts causing stimulation, although the simulation of the real movement is not very good.

Although it is not precluded that each constriction element releases the constriction all at once following successive constriction of all constriction elements, it is recommended that the control element is configured, following successive constriction of all constriction elements, to successively release the constriction of all constriction elements in reverse direction. A greater degree of stimulation is hereby obtained since a more natural movement is simulated.

The invention likewise relates to a method for sexual stimulation of a penis, comprising the steps of placing round the penis a housing with a substantially cylindrical cavity which is open on at least one end and switching on the control element accommodated in the housing, and thereby generating a reciprocally moving constriction of the constriction elements displacing over the length of the cavity at a frequency of between 0.2 and 5 reciprocal movements per second.

It has also been found that a degree of stimulation occurs when the control element is configured to displace the constriction from the open end of the cavity to the closed end of the cavity.

According to a preferred embodiment, the device is provided with at least six constriction elements. Only five constriction elements are applied in the prior art device, which is sufficient for simulating the constrictions of the vagina or of another body part suitable for sexual stimulation. The present invention generates a moving constriction, which requires a larger number of constriction elements. The inventor has found that a good simulation of the movement which takes place during coitus or other sexual gratification is particularly obtained with ten constriction elements. It is of course possible to apply a larger number of constriction elements.

According to a structurally attractive embodiment, the device is provided with at least one camshaft extending in the longitudinal direction of the cavity and drivable by an electric motor, and on which a number of cams corresponding to the number of constriction elements are arranged, and with a sheath of resilient material which surrounds the cavity, and wherein the cams are formed for urging the sheath inward during a part of a revolution of the camshaft when the camshaft is rotated. The sheath imparts to the cavity the texture of a piece of skin or mucous membrane in order to obtain a better simulation of the vagina or other body part for the purpose of sexual stimulation. The sheath further serves to seal the interior of the device. Plastics with a layer of silicones on the inner side can preferably be used. It is noted that the reciprocal movement can be obtained by reversing the direction of rotation of the motor driving the camshaft after a movement has been performed in one direction.

In order to obtain a good distribution of the constriction over the periphery of the cavity it is recommended that the device is provided with at least two camshafts which are distributed uniformly over the periphery of the sheath and each drivable by an electric motor, and on which a number of cams corresponding to the number of constriction elements are arranged. The camshafts can each be driven here by an individual electric motor, although it is also possible for the camshafts to be driven together by one electric motor.

It has also been found that a good degree of stimulation is obtained when the cams are placed on each of the camshafts so as to perform a simultaneous movement.

Preferably present between each of the cams and the flexible sheath is a finger manufactured from resilient material which is connected at one of its ends to a carrier connected to the housing and extending parallel to the cavity. The local pressure exerted by the cams is hereby distributed over a greater area so that a better simulation of a contraction is obtained.

This effect is improved when the fingers extend in the vicinity of the sheath along a substantial part of the periphery of the cavity and when the free end of each of the fingers is configured to be pressed inward by one of the cams.

Use is usually made during use of the device of a condom arranged round the penis. When the penis provided with a condom is inserted into the cavity, air may be enclosed between the sheath and the condom which makes insertion more difficult. In order to prevent this it is recommended that at least one groove extending in the longitudinal direction of the cavity is arranged in the sheath.

The control element is preferably connected to operating means placed on the housing of the device. These operating means comprise not only a switch for switching the device on and off, but also an operating element for controlling the contraction which simulates a reciprocal movement. This movement takes place with a frequency within the stated range so that within this frequency range the desired frequency can be chosen while the degree of constriction can also be chosen.

The operating means preferably comprise an operating element which extends in the longitudinal direction of the cavity, is locally sensitive to contact pressure or locally sensitive to local approach by a conductor by means of capacitive or inductive coupling. This type of operating element is highly suitable for operating the device according to the invention. Provided it extends over the majority of the length of the cavity, the above elucidated linear operating element makes it possible for the constriction of the constriction elements to coincide with the activated location of the operating element.

The user can hereby control the location and the movement of the constriction.

It is however also possible for the control element to be configured to control the frequency of the reciprocal movement of the constriction in accordance with the activated location of the operating element. This frequency will generally lie within the stated frequency range. Nor is it precluded that the operating element is configured to detect the degree of inward pressure and to convert this to a quantity of the output signal with which the control element is controlled. This provides the option for the user to determine not only the frequency of the movement but also the degree of constriction.

The above described method of operation enables autonomous use of the device, although it is likewise possible for the device to be controlled or partly controlled by an external source. Although coupling by means of a cable is not precluded, a further embodiment provides the measure that the control element is configured for operation by an external, preferably wirelessly supplied signal. This control by an external source can go together with a local operation. It is thus possible for one quantity to be controlled locally and the other quantity externally. Control from an external source is particularly attractive when the external source also provides another manner of sexual stimulation, such as a video signal, an audio signal or a combination thereof; the two forms of sexual stimulation can then be synchronized.

As already discussed, it is possible for an external source to control a quantity of the device. It is thus possible that the control element is configured to control the frequency of the contraction under the influence of the externally supplied signal, which contraction in turn simulates the reciprocal movement. The degree of constriction can be controlled here by the user himself. Control of the frequency from an external source is particularly attractive when the external source also provides another manner of sexual stimulation, such as a video signal related to the frequency.

This embodiment moreover provides a method of the above stated type, wherein the control element is connected to a source for an external signal and the frequency is determined by the external signal. As will be elucidated hereinbelow, this external signal can be accompanied by synchronized video images which are related to the relevant frequency.

The degree of constriction need not be applied solely to those constriction elements which are constricted in the context of the simulating reciprocal movement, but it is likewise possible for the control element to be configured to constrict at least a number of constriction elements simultaneously under the influence of the externally supplied signal, whereby constriction takes place over the whole length of the cavity and the moving constriction occurs as an additional constriction.

The signal generated by the control element from the operation of the device is primarily intended to control the constriction elements of the device itself. The signal can however also be used to control the constriction elements of another device according to the invention. Such a combination of devices which are the same is particularly suitable for homosexual contact, wherein the sexual partner makes use of a corresponding device.

As already stated above, the device is suitable for sexual stimulation by means of signals coming from an external source. In order to allow the device to also function as source of signals for sexual stimulation of a remote sexual partner it is recommended that the device is provided with sensors for the dimensions, shape and movement of the penis and for generating a signal which represents these data. The thus generated signal can be used for sexual stimulation of a sexual partner by an apparatus, the form of which depends on the signal generated by the device according to the present embodiment and which can be used by both women and men.

The stimulation during use of the device under the control of an externally supplied signal can be improved when this use is combined with viewing of a video image, which is preferably related to the externally supplied signal. A specific embodiment further relates to a combination of such a device and a digital computer, the memory of which is loaded with a program for displaying a video from the internet on a screen coupled to the digital computer and for operating the control element of the device in accordance with a signal from the Internet which is related to the video shown on the screen.

The control member is preferably configured for operation by an apparatus usable by a sexual partner. This measure can be applied in the case of control by a similar apparatus, for instance when it is configured to supply the control signals not only to the constriction elements but also to the other device. It is however also possible that the apparatus for use by a sexual partner is of a different nature and is suitable for generating control signals for the control element of the device. The first stated situation is particularly suitable for homosexual contact and the latter stated situation is particularly, though not exclusively, suitable for heterosexual contact. This embodiment also relates to a combination of a device of the above stated type and at least one apparatus usable by a sexual partner and configured to operate the device.

A further embodiment relates to an apparatus configured for placing in the vagina of the sexual partner and provided with a number of pressure sensors. The degree of contraction of the vagina can hereby be used to control the degree of contraction of the constriction elements so that a good simulation is achieved. It will be apparent that such an apparatus is particularly suitable for heterosexual contact. It is noted that such as an apparatus can also be used in other situations, for instance for coupling to a similar apparatus for homosexual situations or in therapeutic situations for the purpose of measuring the degree of contraction of the vagina.

It is structurally attractive for the apparatus to be provided with a housing manufactured from hard material and a sheath manufactured from compressible material, wherein the sensors are arranged between the housing and the sheath.

It is also recommended that the sensors are placed on one side of the apparatus and that an elongate sensor, which is configured to detect the extent to which the apparatus has been inserted into the vagina, is placed on the other side of the apparatus. Not only can the extent of insertion into the vagina be hereby detected, the signal coming from the elongate sensor can also be used to assign a weighting factor to the signals coming from the other sensors.

The apparatus can be used by a sexual partner present a short distance from the user, for instance in the same space. A specific embodiment provides for this purpose the measure that the control element is configured for coupling over a short distance via a wireless connection to the at least one apparatus usable by a sexual partner. Although the invention in this configuration is suitable for heterosexual contact, it is particularly suitable for homosexual contact; use can after all then be made of two devices according to the invention, which can both be used by a man.

According to another preferred embodiment the control element is configured for coupling via the internet to the at least one apparatus usable by a sexual partner. In many situations use is made for this purpose of a video signal relating to the control signal, so that the user of the device can view the acts of his/her sexual partner. Use is preferably made for this purpose of a video camera at the location of the sexual partner and a screen at the location of the user. It is thus possible to have sexual contact with a partner elsewhere in the world. This can be applied for both heterosexual contact and homosexual contact.

It is however also possible for the video signal to come from a commercial ‘webcam’, with a camera which is directed at a person performing sexually stimulating acts in a professional setting. This person then makes use of an apparatus for generating control signals for the apparatus according to the invention in order to thus improve the experience of a ‘webcam’. In this application more than one device can be connected to the single camera and the single apparatus.

This embodiment also relates to a combination of a device of the above stated type and a digital computer programmed to operate the control element, wherein the program loaded into the memory of the computer is configured to operate the operating means in accordance with operating signals coming from the apparatus used by the sexual partner and received via the internet, and to receive via the internet images of the sexual partner to be displayed on a screen coupled to the computer.

Particularly in situations where sexual intercourse is desired in both directions, for instance between two sexual partners at different locations in the world, it is recommended that the apparatus usable by the sexual partner is configured for sexual stimulation of the partner. The apparatus usable by the sexual partner is therefore preferably configured for sexual stimulation of the partner. This embodiment can also be applied for homosexual and for heterosexual intercourse.

This embodiment is preferably configured to supply signals generated by the sensors of the device to a control element of the apparatus for sexual stimulation of the partner.

The present invention will be elucidated hereinbelow with reference to the accompanying drawings, in which:

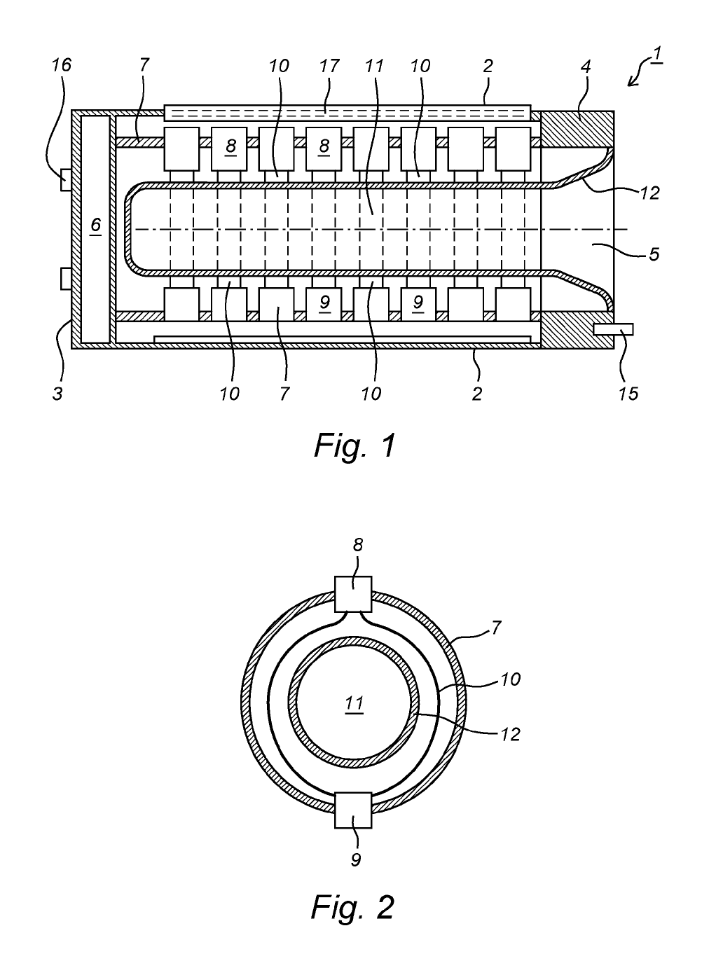

FIG. 1 is a cross-sectional view of a device according to a first embodiment of the invention;

FIG. 2 is a schematic perspective view of a part of the device shown in FIG. 1;

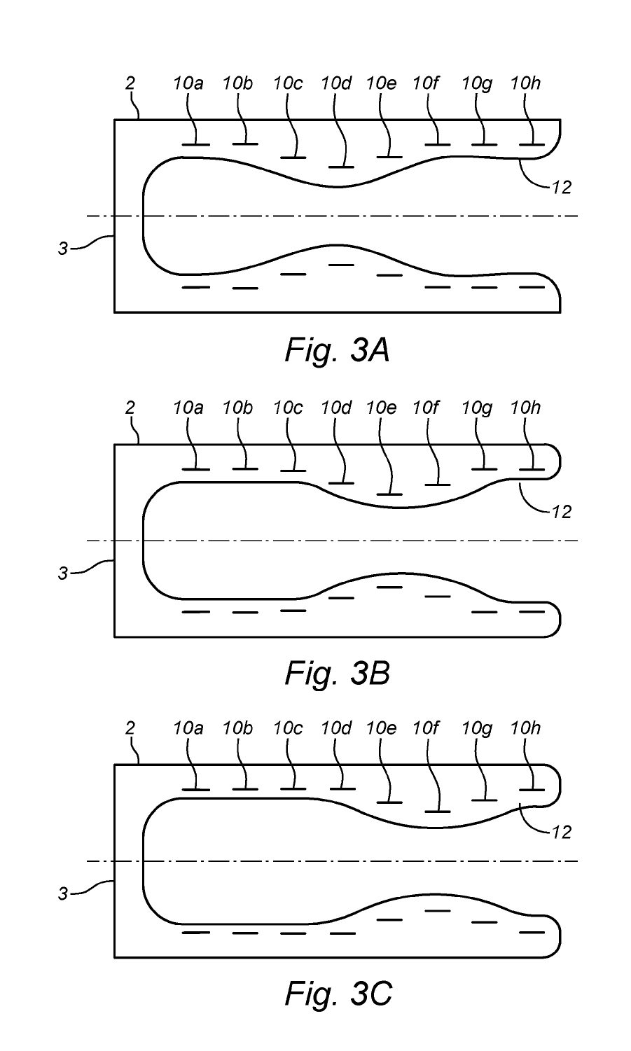

FIGS. 3A-3C are simplified cross-sectional views of a propagating constriction in the device shown in FIG. 2;

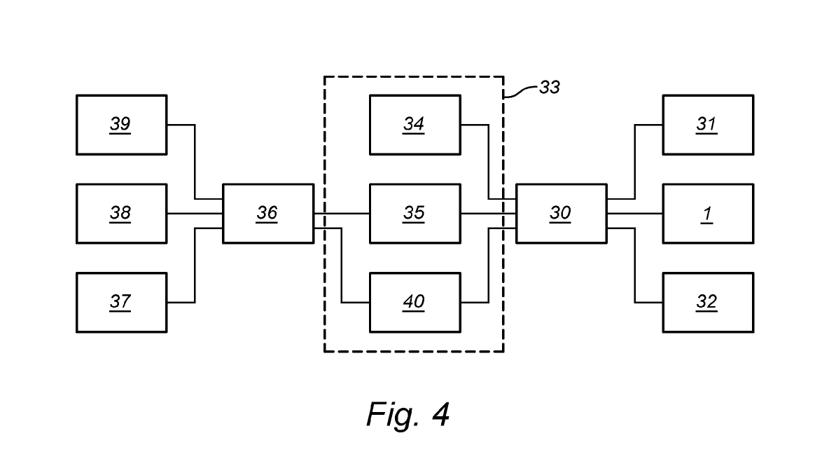

FIG. 4 shows a block diagram elucidating the operation of the invention;

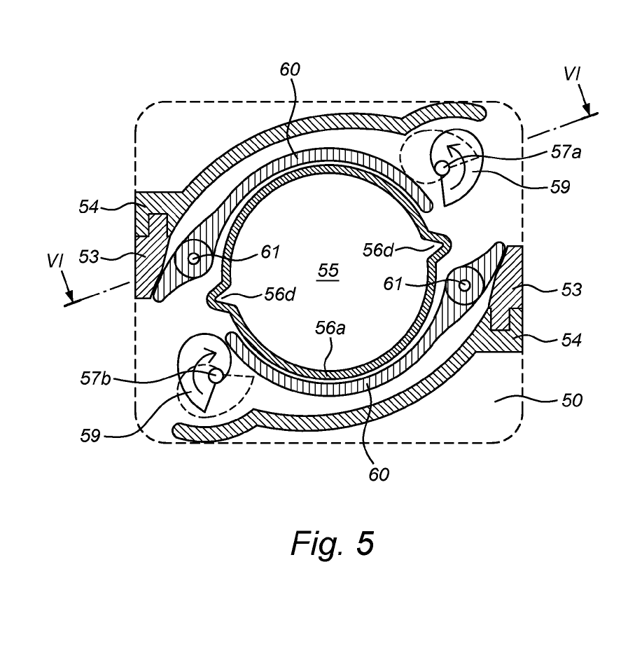

FIG. 5 is a cross-sectional view of a second embodiment;

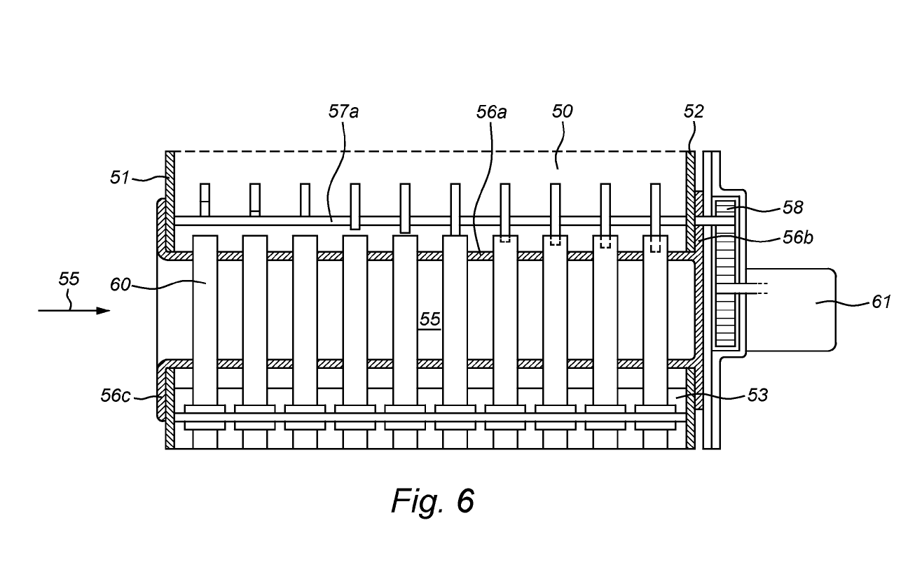

FIG. 6 is a view in longitudinal section along the line VI-VI in FIG. 5; and

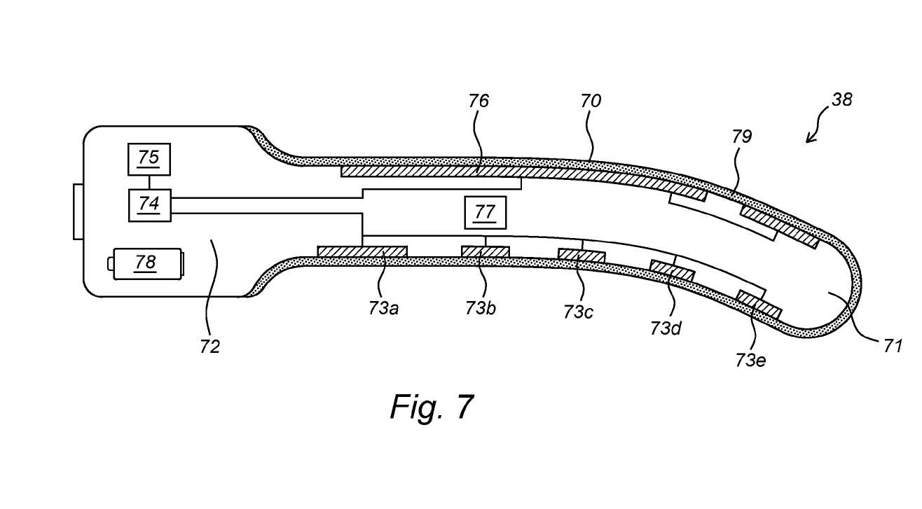

FIG. 7 is a cross-sectional view of an apparatus for use in the invention.

The device shown in FIG. 1 and designated as a whole with ‘1’ comprises a housing 2 with the form of a straight cylinder. Housing 2 is closed at one of the ends with an end wall 3, while a ring 4 with an opening 5 is arranged at the other end of housing 2. Arranged against end wall 3 in the housing is an electronics housing 6 in which a significant part of the electronic components necessary for the operation of the device is accommodated. A cylindrical inner housing 7 is placed between this electronics housing 6 and ring 4. Eight constriction elements 8 are arranged along an axial line in cylindrical inner housing 7. Eight guides 9 are arranged along the radially opposite line in inner housing 7. The two ends of a belt 10 trained in a loop are attached to each of the constriction elements 8. The loop of each of the belts 10 is guided via the associated guides 9. It is possible to make use of more guides placed over of the periphery of inner cylinder 7. The loop of each of the belts is substantially concentric so that each of the belts 10 surrounds a cavity 11 extending over a substantial part of the length of the device. Arranged in cavity 11 is a sheath 12 which is closed at the closed end of the device and which is connected releasably to ring 4. Constriction elements 8 are each connected to the electronic circuit accommodated in electronics housing 6.

Placed in ring 4, which is arranged at the open end of the housing, are a rechargeable battery and a USB connection 15 for charging the battery and updating the software in the control element. Transmission of operating signals from and to the device takes place by means of a wireless connection, such as a Wi-Fi connection over a short distance or a Bluetooth connection, so that there are no cables present during use. Other connection protocols are not precluded. The electronic circuit placed in electronics housing 6 is provided for this purpose with a transmitter, a receiver and an antenna. The electronic circuit also comprises a digital processor for processing the received signals and controlling constriction elements 8. An on/off switch 16 is placed on end surface 3. Placed on cylindrical housing 2 is an axially extending elongate switch or sensor 17 which is sensitive to touch, pressure or approach and which produces a signal which indicates the location where sensor 17 is activated. If sensor 17 is pressure-sensitive, it can likewise produce a signal which is a measure of the pressure with which the sensor is pressed.

The construction of the device is further elucidated with reference to FIG. 2. FIG. 2 shows a section of a single unit of a constriction element 8, a guide 9 and a belt 10. Interior sheath 12 is also shown in this figure. It will be apparent that the device comprises eight of such units. Although not present in the present embodiment, it is likewise possible for the constriction elements to also be placed resiliently relative to the frame.

The operation of this device will now be elucidated. Each constriction element 8 is configured to take in one or both ends of belt 10 upon activation so that the loop formed by belt 10 becomes smaller. Constriction element 10 operates proportionally so that the signal supplied to the constriction element determines the extent to which the belt is constricted. Such a device is also referred to as a servo, but may in future also be replaced by another drive mechanism. Cavity 11 is narrowed locally by shortening the belt. The cavity is narrowed over a determined length by actuating several constriction elements simultaneously. A narrowing moving reciprocally along the length of the cavity can be formed by successively actuating the constriction elements.

The propagating constriction is shown in FIGS. 3A, 3B and 3C. In FIG. 3A belt 10d is fully constricted and the two adjacent belts 10c and 10e are about half-constricted. This creates a gradual constriction of the cavity. FIG. 3B shows the situation at a slightly later point in time. Belt 10e is then fully constricted and the two adjacent belts 10d and 10f are half-constricted. The situation at an even later point in time is shown in FIG. 3C. Belt 10f is fully constricted here and the two adjacent belts 10e and 10g are about half-constricted. A propagating constriction is thus created which simulates the movement during sexual stimulation. It will be apparent that, once an outermost belt is reached, the direction of the constriction is reversed.

It is noted that within the context of the invention the frequency of the movement, and possibly the extent of constriction, can be determined by the user him/herself by operating sensor 17 or can be determined by an external signal source, within the frequency range determined by the invention. External signal sources can also be used to determine other quantities, such as the degree of constriction outside the range determined by the movement.

A second embodiment of the invention is shown in FIGS. 5 and 6. This second embodiment is provided with a frame 50 shown in broken lines, which is placed in a housing (not shown). Frame 50 comprises two end walls 51, 52 which are connected by frame elements which extend in longitudinal direction and two of which, i.e. 53, 54, are shown. The frame is preferably manufactured from strong plastic. Arranged in end walls 51, 52 and in the frame is a cavity 55 in which is arranged a sheath 56 manufactured from flexible material such as a soft plastic. Sheath 56 has a cylindrical part 56a extending in cavity 55, a flat part 56b extending in contact with and outside end wall 52, and a collar 56c extending outside and in contact with end wall 51. The interior of cylindrical part 56a is accessible via the opening in collar 56c. Arranged in cylindrical part 56a are two grooves 56d which serve to allow air to escape during insertion of an erect penis provided with a condom.

Two camshafts 57a,b further extend between end walls 51, 52 parallel to the longitudinal direction of cavity 55. The camshafts hearing-mounted in the end walls extend outside end wall 52 and the protruding parts are provided with gear wheels 58. Ten cams 59a-59j are placed fixedly on each of the camshafts. Cams 59a-59j all have a slightly different form. It is possible to place the cams such that they press sheath 56a inward during rotation of camshaft 58.

Arranged according to the present embodiment however are a number of fingers 60a-60j manufactured from resilient material and extending substantially in tangential direction relative to the axis of cavity 55. At one of their ends the fingers 60 are each placed rotatably on a shaft 61 extending parallel to camshafts 57, and on their other side they are in contact, during at least a large part of the rotation of camshafts 57, with the associated cam 59. The fingers extend beyond shaft 61 with an extension piece of finger 60 which is in contact with one of the parts 53 of frame 50, this such that extension 61 operates as a spring. This spring urges fingers 60 outside sheath 56, but fingers 60 are forced by the associated cam 59 to press the sheath 56 inward during rotation of camshaft 56 for the purpose of obtaining the constriction of the sheath. It is otherwise also possible for the springs to be arranged fixedly in a part of the housing and for the spring action to be obtained solely through the resilience of the material.

Use is made of an electric motor 62 to drive the camshafts. This electric motor 62 is received in a flange 63 which is also provided with cavities for gear wheels 64 connected to electric motor 62. Flange 63 is placed against flat part 56b of sheath 56, after which flange 63 is connected to the end wall 52 lying under the flat part, for instance by being enclosed in the housing (not shown in the figures). The control member is configured here to control the motors.

Cams 59 will rotate when camshaft 57 is rotated through driving of electric motor 62 via gear wheels 63 and 58. Cams 59a-j all have a different profile and they each touch one of the fingers 60a-j. Fingers 60 are hereby urged toward sheath 56 in accordance with the profile of cam 59 so that sheath 56 is urged inward in accordance with the profile of the cams and a constriction is created. Cams 59a-j preferably have successive profiles such that the constriction is propagated from the opening of cavity 56 to the other side of the cavity. The constriction is more preferably maintained until the constriction is released all at once over the whole length of the cavity. This cycle is repeated as camshaft 57 is rotated further. It is however recommended that, following propagation of the constriction to the closed side of the cavity, the constriction moves back again. The rotation direction of the electric motor driving the camshafts is for this purpose reversed.

It is not precluded that cams 59 are formed differently, for instance for the purpose of obtaining a temporary constriction propagating in the longitudinal direction and releasing again immediately thereafter, or a number of successive constrictions propagating in the longitudinal direction. Nor is it precluded that the constriction moves in the opposite direction when camshaft 57 is driven in the reverse direction. This does require an appropriate shaping of the cams in order to prevent jamming.

The shown embodiment is provided with two camshafts 57a,b, each provided with a number of cams 59 which are each in contact with a finger 60. Each of the constriction elements is therefore provided with two fingers 60 and two cams 59. A sufficient control of the periphery of sheath 56 is hereby achieved. It is possible in principle to make use of a single camshaft 59, although the inward pressing of sheath 56 will then be eccentric. Applying more camshafts, such as three or four camshafts, with an appropriate number of cams and fingers enables a better distribution over the periphery of the sheath.

Because the form of cams and the placing of the cams on the shafts determine the progression of the constriction, the control member determines only the rotation speed of the motor, and thereby the frequency of the constrictions.

FIG. 4 shows a block diagram of a situation in which the device according to the invention is applied. The device according to the invention designated 1 is connected to a computer 30 which is coupled to a screen 31, which includes a loudspeaker, and a camera 32 which includes a microphone. Computer 30 is connected to the internet 33 which comprises among other things a source 34 of erotically stimulating visual material which is provided with an additional signal for controlling the device according to the invention. The internet further comprises a webcam site 35 which connects to a computer 36, which is connected to a camera 37 directed at women providing erotic entertainment. The women use an apparatus 38 which is configured to generate signals for controlling device 1. The women also have a screen 39 for the purpose of receiving instructions, as is usual in such a situation. Although reference is made above to women, it will be apparent that the function in question can also be fulfilled by men. It is noted that it is possible to connect the webcam site via the internet to a large number of devices according to the invention, which can result in economic advantage, since a large number of users can make simultaneous use of the images and the signals.

A final, currently provided application envisages offering erotic contact between sexual partners at a great distance. The two partners have a respective computer 30 and 36 connected to the internet and connected to a respective camera 32 and 37, preferably provided with a microphone, and to a respective screen 31 and 39, preferably with a loudspeaker. Connection via the internet takes place via a website 40. Assuming the relationship is a heterosexual one, one of the partners has a device according to the invention 1 and the other partner has an equivalent apparatus for women. For other types of relationship use can be made of other combinations of apparatus.

The present invention therefore also provides an apparatus 38 for use by women, which is configured to provide control signals for controlling a device according to the invention. Apparatus 38 comprises a substantially cylindrical part 70, preferably manufactured from a hard plastic and having a rounded head 71. The shape can further be adapted to that of an erect penis. Placed on the side remote from head 71 is a handgrip 72 with which the female user can handle the apparatus. Five pressure sensors 73a-73e are placed on the upper side of the substantially cylindrical part 70. The pressure sensors are connected to a transmitter processor 74 incorporated in the handgrip for the purpose of processing and transmitting the relevant signals to transmitter 75, for instance a Bluetooth transmitter. Placed on the underside is a single elongate pressure sensor 76 which is configured to detect the extent to which the apparatus has been inserted into the vagina. This elongate pressure sensor 76 is likewise connected to processor 74 which serves to convert the signals generated by the other pressure sensors. The elongate pressure sensor 76 can otherwise also be formed by a series of individual sensors. Preferably though not necessarily placed in cylindrical body 71 for sexual stimulation of the female user is a vibrator 77, which is preferably powered by a battery 78 placed in the handgrip. The apparatus is preferably also provided with a thin sheath of flexible material 79 in order to increase the comfort of the female user.

It will be apparent that numerous variations are possible within the scope of the invention as defined by the claims.

1.-28. (canceled)

29. A device for sexual stimulation of a penis, comprising:
a housing with an elongate, substantially cylindrical cavity which is open on at least one end and configured to receive a penis;
a number of constriction elements with an opening which are placed in the housing and arranged adjacently of each other in axial direction, wherein the cavity extends through each of the openings and the constriction elements are each configured, when activated, to constrict their opening; and
a control element placed in the housing for controlling the controllable size of the opening of each of the constriction elements,
where in
the control element is configured to generate at least one temporary constriction of the constriction elements displacing over the length of the cavity along the constriction elements at a frequency of between 0.2 and 5 constrictions per second.

30. The device as claimed in claim 29, wherein the control element is configured, following successive constriction of all constriction elements, to successively release the constriction of all constriction elements in reverse direction.

31. The device as claimed in 29, wherein the control element is configured to successively displace the constriction in both directions.

32. The device as claimed in claim 29, wherein the device is provided with at least six constriction elements, and preferably with ten constriction elements.

33. The device as claimed in claim 29, wherein the device is provided with at least one camshaft extending in the longitudinal direction of the cavity and drivable by an electric motor, and on which a number of cams corresponding to the number of constriction elements are arranged, and with a sheath of flexible material which surrounds the cavity, and that the cams are formed for urging the sheath inward during part of a revolution of the camshaft when the camshaft is rotated.

34. The device as claimed in claim 33, wherein the device is provided with at least two camshafts which are distributed uniformly over the cross-section of the sheath and each drivable by an electric motor, and on which a number of cams corresponding to the number of constriction elements is arranged and that on each of the camshafts the cams are placed on the camshafts so as to perform a simultaneous movement.

35. The device as claimed in claim 34, wherein a finger manufactured from resilient material which is connected at one of its ends to a carrier connected to the housing and extending parallel to the camshaft is present between each of the cams and the flexible sheath and that the fingers extend in the vicinity of the sheath along a substantial part, of the periphery of the cavity and that the free end of each of the fingers is configured to be pressed inward by one of the cams.

36. The device as claimed in claim 29, wherein the control element is connected to operating means placed on the housing of the device.

37. The device as claimed in claim 35, wherein the operating means are provided with an elongate operating element which extends parallel to the longitudinal direction of the cavity, is locally sensitive to contact pressure or locally sensitive to local approach by a conductor by means of capacitive or inductive coupling.

38. The device as claimed in claim 29, wherein the control element is configured to control the frequency of the reciprocal movement of the constriction in accordance with the activated location of the operating element or under the influence of an externally supplied signal.

39. The device as claimed in claim 29, wherein the control element is configured to transmit the control signals from the contraction elements to an external receiver ,and that the device is provided with sensors for the dimensions, shape and movement of the penis and for generating a signal which represents these data.

40. A combination of the device as claimed in claim 38 and a digital computer, the memory of which is loaded with a program for operating the control element of the device, wherein the program loaded into the memory of the computer is configured for displaying a video from the internet on a screen coupled to the digital computer and for operating the control element of the device in accordance with a signal from the internet which is related to the video shown on the screen.

41. The device as claimed in claim 38, wherein the device is configured for coupling to and operation by at least one apparatus usable by a sexual partner and configured to control the device.

42. An apparatus for use by a sexual partner of the user of a device as claimed in claim 41, wherein the apparatus is an apparatus configured for placing in the vagina of the sexual partner and provided with a number of pressure sensors, a housing manufactured from hard material and a sheath manufactured from compressible material, and that the sensors are arranged between the housing and the sheath.

43. The device as claimed in claim 42, wherein the control element is configured for coupling over a short distance via a wireless connection to the at least one apparatus usable by a sexual partner or for coupling via the internet to the at least one apparatus usable by a sexual partner.
